(19) United States
(12) Patent Application Publication
(10) Pub. No.: US 2003/0061849 A1
(43) Pub. Date: Apr. 3, 2003

(54) Motor-driving lock

(76) Inventor: Tsun-Tsai Yeh, Hsinchu (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/107,668

(22) Filed: Mar. 26, 2002

(30) Foreign Application Priority Data
Oct. 3, 2001 (TW) 90216793

(51) Int. Cl. E05B 47/00

(52) U.S. Cl. 70/279.1; 70/280

(57) ABSTRACT

A motor-driving lock includes a lock bolt for mounting in a door and having a rotary core and a latch drivably connected with the core. An inner lock unit having a base for being attached to an inside of the door, having a transmission mechanism having a rotary shaft rotated by a drive device. An outer lock unit for being attached to an outside of the door and having an elongated rotor rotatably mounted in the outer lock unit and fittingly extending through the rotary core and the rotary shaft such that when the rotary shaft rotates, the rotary core rotates accordingly, thereby to motivate the latch to extend or retract. The drive device includes a motor for driving a worm via a group of gears. The worm is use for driving a furcated component to move linearly. The furcated component has a rack engaging with a driven gear which is secured with the rotary shaft.

### BACKGROUND OF THE INVENTION

1. Field of the Invention

The present invention relates to a door lock, and more particularly to a motor-driving lock that incorporates an electrically operated driving mechanism to control latching and unlatching operations of the motor-driving lock. The instant invention relates to a copending application filed Mar. 26, 2002 with an unknown serial number and the same applicant, titled as “HORIZONTAL MOTOR-DRIVEN LOCK”.

2. Description of Related Art

A door lock is indispensable in our living. A traditional hand-operated lock needs people insert a key into a keyhole and rotate the key so as to rotate a rotor which rotates a lock bolt, thereby to latch or unlatch the lock. In this manner, the stability and reliability of the traditional lock are acceptable. Yet on some occasions such that when a user has no hand free or needs to latch a plurality of locks at the same time, the traditional lock causes inconvenience to the user. In order to overcome these problems, an electrical motor-driving lock comes into use. U.S. Pat. Nos. 3,767,240, 4,438,962, 4,483,162, 5,790,034, 5,857,365, 5,979,199, 6,012,310 and 6,032,991, disclose some examples.

In a prior art, a motor-driving lock includes a motor drives a driven wheel which rotates a rotor in the lock so as to electrically control the latching or unlatching operation of the motor-driving lock. In order to detect whether the lock is in a latching state or a unlatching state, a detecting mechanism is provided in the lock. However, the detecting mechanism of the conventional motor-driving lock is complicated and cannot always reliably function. The lock further includes a drive device having a bevel gear connected to the motor so as to output the power of the motor and a special gear meshing with the bevel gear. The special gear integrally comprises a spur gear part and a bevel gear part. At the same time, the spur gear part meshes with a driven gear.

It is obvious that the structure of the drive device in the prior art is very complicated. Moreover the bevel gear is difficult to manufacture and assemble, which increases the cost of the motor-driving lock. Improvements are therefore desirable so as to provide a motor-driving lock with simple structure, low cost and high reliability and stability.

### SUMMARY OF THE INVENTION

Accordingly, an object of the present invention is to provide a motor-driving lock with simple structure and low cost.

Another object of the present invention is to provide a motor-driving lock which has a simple and reliable position detecting mechanism by which the position of the lock can always be ensured.

To achieve the above objects, a motor-driving lock in accordance with the present invention comprises a lock bolt for being mounted in a door, an inner lock unit for being attached to an inside of the door and an outer lock unit for being attached to an out side of the door. The lock bolt has a rotary core and a latch drivably connected with the core. The inner lock unit includes a transmission mechanism having a rotary shaft and a drive device for rotating the rotary shaft. The drive device includes a motor for driving a worm via a group of gears. The worm is used for driving a furcated component to move linearly. The furcated component has a rack engaging with a driven gear which is secured with the rotary shaft. The outer lock unit has a elongated rotor rotatably mounted thereon and fittingly extending through the rotary core and the rotary shaft such that when the rotary shaft rotates, the rotary core rotates accordingly, thereby to motivate the latch to extend or retract.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of a motor-driving lock in accordance with the present invention;

FIG. 2 is an exploded view of an inner lock unit of the motor-driving lock of FIG. 1;

FIG. 3 is a perspective view of a furcated component of the inner lock unit of motor-driving lock of FIG. 1;

FIG. 4 is a perspective view of the inner lock unit of the motor-driving lock of FIG. 1, wherein the lock is at a start position;

FIG. 5 is similar to FIG. 4, showing the lock at an end position; and

FIG. 6 is a perspective view of the assembled inner lock unit and an upper casing to be mounted to the inner lock unit of FIG. 2.

### DETAILED DESCRIPTION OF THE INVENTION

Reference will now be made to the drawing figures to describe the present invention in detail.

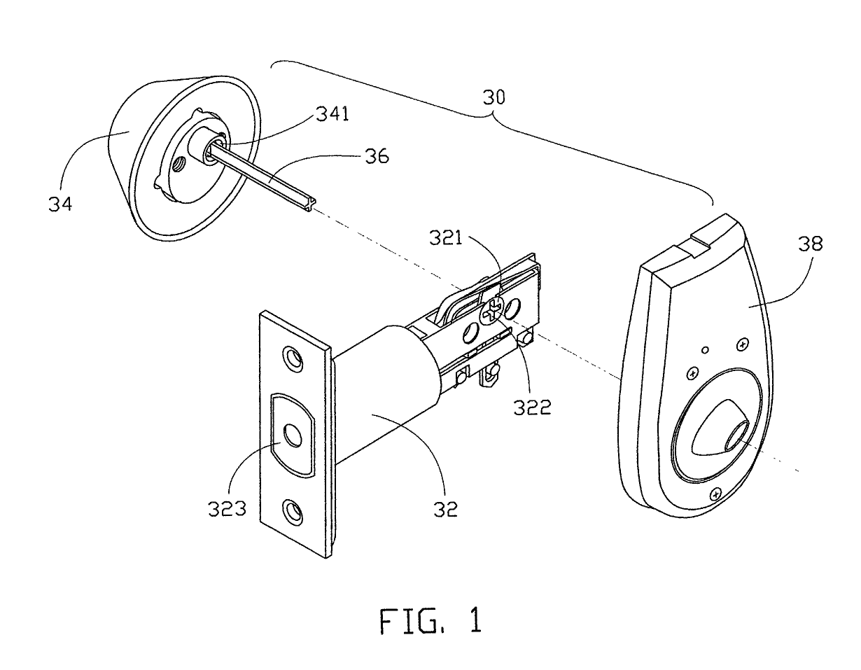

Referring to FIG. 1, a motor-driving lock 30 of the present invention comprises a lock bolt 32 fixedly mounted in a door and including a rotary core 321 rotatably mounted therein. The rotary core 321 defines a cross-shaped slot 322 therein. An outer lock unit 34 is to be attached to an outside of the door and an inner lock unit 38 is to be attached to an inside of the door. The outer lock unit 34 includes an elongated rotor 36 rotatably mounted thereon. The rotor 36 has a cross-shaped profile and is used to be fitted into the slot 322 and a cross-shaped slot defined in the inner lock unit 38 which will be described later, thereby to interconnect the outer lock unit 34, the lock bolt 32 and the inner lock unit 38.

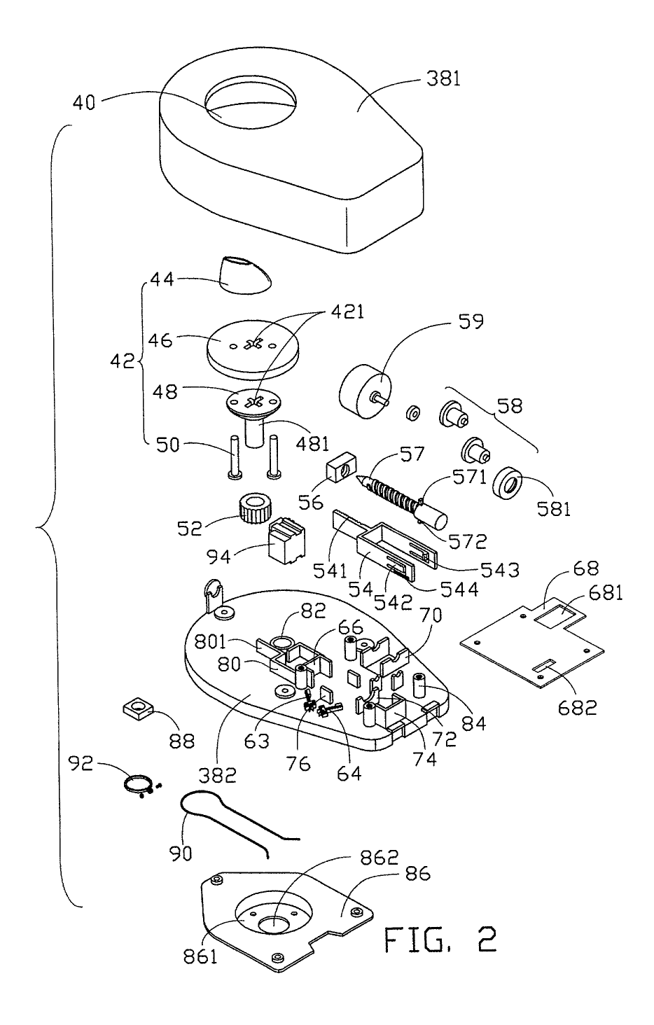

Also referring to FIG. 2, the inner lock unit 38 includes a housing composed of an upper casing 381 and a base 382 which are coupled together via interlocking means. i.e., hooks (not shown) formed in the upper casing 381. The upper casing defines a nummular opening 40 thereon. Within the housing, a transmission mechanism 42 and a drive device used for rotating the transmission mechanism 42 are mounted.

The transmission mechanism 42 includes a rotary base 48, a rotary shaft 481 integrally extending from a lower surface of the base 48, a support base 46 placed on the rotary base 48, and a knob 44 placed on the support base 46. The rotary base 48 and the support base 46 and the knob 44 are connected together by two spaced screws 50 and respectively define cross-shaped slots 421 which are to be aligned with the slot 322.

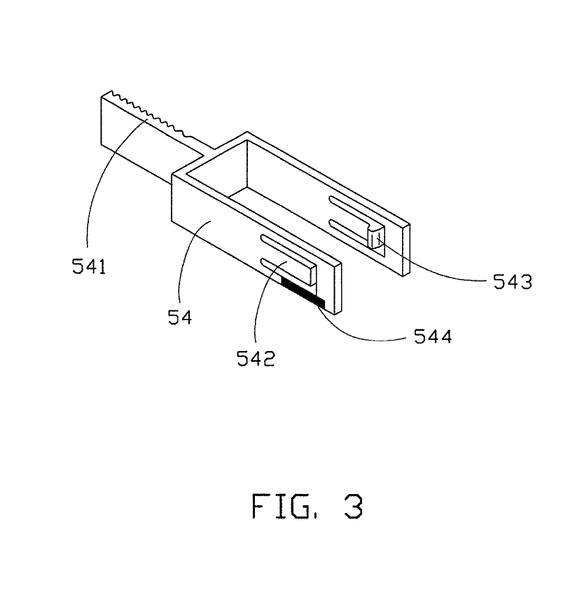

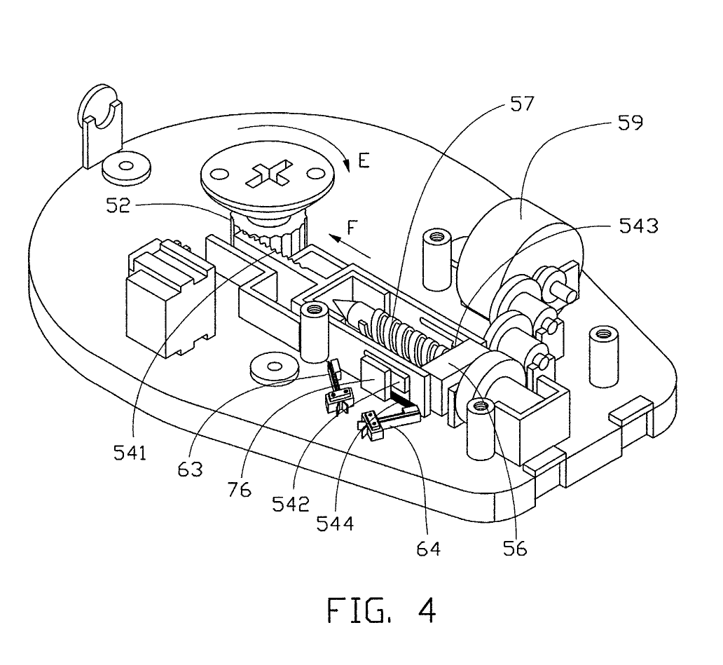

The drive device comprises a driven gear 52 fixedly mounted on the rotary shaft 481 for rotating therewith, a furcated component 54 movably mounted on the base 382 and having a U-shaped part and a rack part 541 integrally projected from the U-shaped part. The rack part 541 is used to mesh with the driven gear 52 so that when the furcated component 54 moves to and fro, the driven gear 52 rotates clockwise and counterclockwise (as shown in FIG. 3 and FIG. 4). The U-shaped part includes two parallel resilient strips 542 and a small protrusion 543 projected inwardly from each resilient strip 542. The drive device further comprises a worm 57 and a slide block 56 meshing with the worm 57. The worm 57 and the slide block 56 are both received in the U-shape part of the furcated component 54, The worm 57 has two keys 571 and 572 and is retained in the slide block 56 and a bracket 72 which is fixedly mounted on the base 382. When the worm 57 rotates, the slide block 56 is driven to move linearly. The furcated component 54 is thereby driven by the slide block 56 to move linearly by the engagement between the block 56 and the small protrusion 543. A group of gears 58 is used for transmitting a driving force from an electrical motor 59 to the worm 57 thereby driving the worm 57 to rotate. The group of gears 58 is retained in corresponding brackets (not labeled). A final gear 581 of the group of gears 58 is fitted to the worm 57 by the keys 571, 572. The motor 59 used for driving the group of gears 58 is retained in two brackets 70.

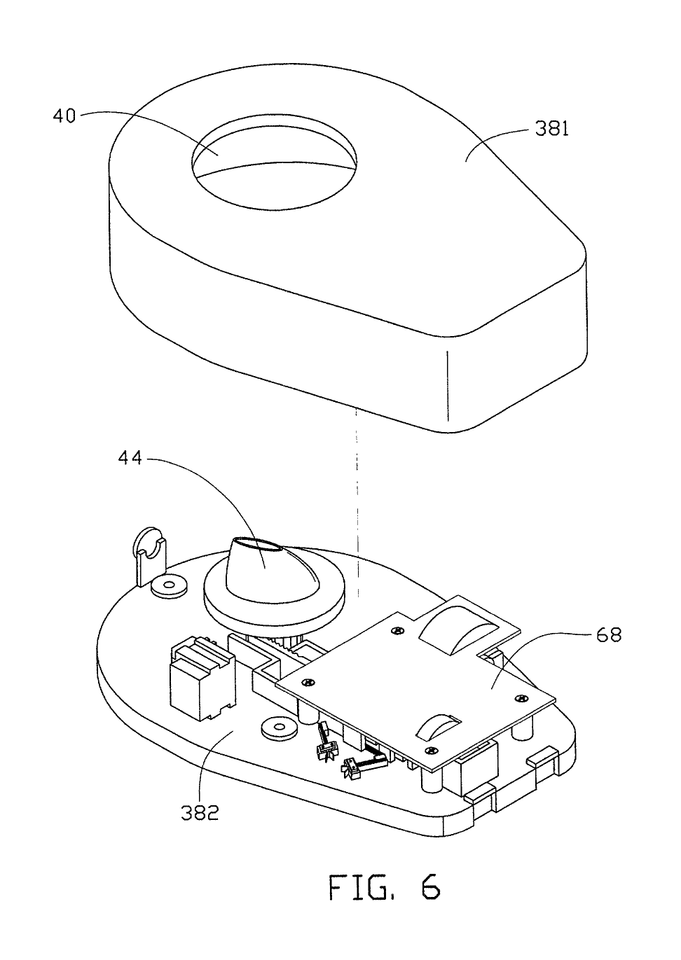

In addition, a sensor plate 544 is attached to an outer face of a wall of the U-shaped part below the resilient strips 542. Two switches 63 and 64 are mounted on the base 382. When the furcated component 54 moves linearly, the sensor plate 544 engages with either the switch 63 or 64, thereby to precisely decide that the lock is latched or unlatched. In order to secure the furcated component 54 to move in a determined direction, a slideway 80 and a pair of positioning blocks 76 are mounted on the base 382. The slideway 80 includes a foreside 801 for securing the rack part 541 of the furcated component 54 meshing with the driven gear 52. A U-shape block 66 is received in the slideway 80 and will stop the furcated component 54 when the furcated component 54 reaches its front end position. Also, a cover plate 68 having two rectangle openings 681 and 682 is placed on the drive device. The motor 59 and the gear 581 extend through the corresponding rectangle openings 681 and 682 of the cover plate 68 (better shown in FIG. 6), The cover plate 68 is fixed to the base 382 via four locking screws engaged with four corresponding threaded posts 84 which are provided on the base 382. The cover plate 68 prevents the components therebelow from being dusted. A sleeve 82 for supporting the driven gear 52 integrally protrudes from the base 382 and defines a through hole for receiving the rotary shaft 481 therein.

Besides, an electrical connector 94 is mounted on the base 382 which is used to connect with an external control circuit (not shown) such as a remote control signal receiving circuit and the motor, whereby a remote control of the motor-driving lock 30 in accordance with the present invention can be remotely controlled.

The inner lock unit 38 further comprises a positioning plate 86 fixed to the base 382 opposite to the upper casing 381. The positioning plate 86 defines a receiving recess 861 and a central hole 862 in the receiving recess 861 for receiving the rotary shaft 481 therein. A restraining block 88, a gasket 92 and a spring 90 are fitted around the rotary shaft 481 between the base 382 and the positioning plate 86. As in the conventional door lock, the spring 90 cooperates with the restraining block 88 to provide a return force to the rotary shaft 481 so that after the rotary shaft 481 is turned in one direction, it can be returned to its original position by the action of the spring 90.

In the illustrated embodiment, the furcated component 54 is adopted as a force transmission component, and now it will be further described by referring to FIG. 3. The furcated component 54 comprises the U-shaped part and the rack part 541 integrally extending from a closed front end of the U-shaped part. The resilient strip 542 itself is a part of the U-shaped part.

In assembly, referring now to FIGS. 4, 5 and 6, the inner lock unit 34 is assembled first. The furcated component 54 with a sensor plate 544 attached thereon is placed between the slideway 80 and the U-shape block 66 and within the pair of positioning blocks 76 so that the rack part 541 of the furcated component 54 abuts against the foreside 801 of the slideway 80. Then the motor 59 and the group of gears 58 are mounted in the corresponding brackets, and the gear 581 is connected with the worm 57 through the keyed joint of the keys 571, 572. At the same time, the slide block 56 meshes with the worm 57. After that, the worm 57 and the block meshing with it are together located on the base 382 within the U-shaped part of the furcated component 54, whereby the furcated component 54 can be driven by motor 59 to have a linear movement. In order to prevent the above-mentioned components from being dusted and make them as an integral unit, the cover plate 68 is fixedly placed thereon through the screw joint. Then the pair of switches 63 and 64 and the electrical connector 94 are mounted on the proper place of the base 382.

Thereafter, the transmission mechanism 42 is assembled. After the knob 44, the support base 46 and the rotary base 48 are connected together via the screws 50, the driven gear 52 is fixedly fitted to the rotary shaft 481 of the rotary base 48. Then the rotary shaft 481 is inserted into the through hole of the sleeve 82 so that the driven gear 52 is supported by the sleeve 82 and simultaneously meshes with the rack part 541 of the furcated component 54.

After the rotary shaft 481 is fitted to the sleeve 82, the restraining block 88, the gasket 92 and the spring 90 are in turn fitted around the rotary shaft 481. Then the base 382 and the positioning plate 86 are fixed together by screw joint. Finally, the cover 381 is attached to the base 382 to obtain the inner lock unit 38 of FIG. 1.

Referring again to FIG. 1 with reference to FIG. 2, one end of the elongated rotor 36 is rotatably mounted in the outer lock unit 34 by a conventional manner, the other end of the elongated rotor 36 fittingly extends through the slot 322 defined in the rotary core 321 into the slots 421 of the support base 46 and rotary base 48 of the transmission mechanism 42. Thus, the motor-driving lock 30 of the present invention is obtained. The rotary core 321 is drivably connected with a latch 323 of the lock bolt 32 by a conventional manner. When the rotary core 321 is rotated, the latch 323 has a linear movement to extend out of the lock bolt 32 or be received therein.

In operation, referring to FIGS. 2 and 4, at the start position in which the latch 323 is received in the lock bolt 32, the switch 64 contacts the sensor plate 544 at this moment. When the motor 59 rotates in first direction, the group of gears 58 is driven by the motor 59 to rotate the gear 581 which rotates the worm 57 so as to drive the slide block 56 linearly move in F direction. The slide block 56 pushes the furcated component 54 to move also in F direction so that the driven gear 52 is rotated in E direction by the rack part 541 of the furcated component 54 meshing with the driven gear 52. The rotation of the driven gear 52 causes the rotary base 48, the support base 46, the elongated rotor 36 and the rotary core 321 to rotate accordingly. Thus, the latch 323 is driven to extend out of the lock bolt 32.

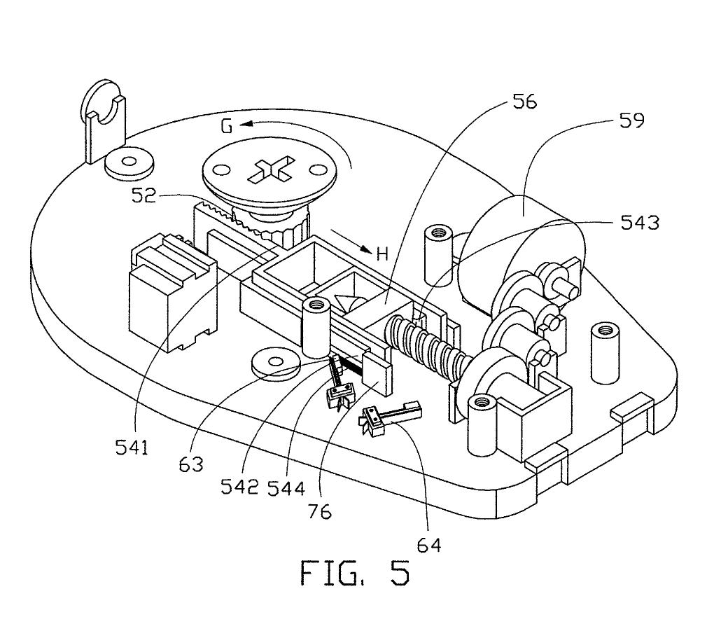

During the above operation, the resilient strip 542 is prohibited by the pair of positioning blocks 76 from projecting out of the side walls of the U-shaped component. When the resilient strip 542 slides away from the positioning blocks 76 and the furcated component 54 is structurally stopped in position, the resilient strip 542 may extend outward, and thus the slide block 56 passes over the small protrusion 543. As can be best seen in FIG. 5 with reference to FIG. 2, as soon as the slide block 56 passes over the small protrusion 543, the sensor plate 544 contacts the switch 63 whereby a signal is given to a control circuit (not shown) of the motor to shut down the motor 541.

When a signal is given to the motor 59 to rotate in a second direction opposite to the first direction, the slide block 56 moves in H direction by the rotation of the worm 57. During this operation, the slide block 56 engages with the small protrusion 543 to push the furcated component 54 to move in H direction so that the driven gear 52 is rotated in G direction by the rack part 541 of the furcated component 54. Thus, the transmission mechanism 42 and the elongated rotor 36 are rotated, thereby to retract the extended latch 323. When the furcated component 54 is structurally stopped in position and the slide block 56 passes over the small protrusion 543 and returns to the original position, the sensor plate 544 again contacts the switch 64 so as to shut down the motor 59 by the motor control circuit (not shown).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A motor-driving lock comprising:
a lock bolt adapted to be fixedly mounted in a door, said lock bolt comprising a rotary core rotatably mounted therein and a latch drivably connected with the rotary core in a manner that when the rotary core rotates, the latch has a linear movement to protrude out of the lock bolt or retract to be received in the lock bolt;
an inner lock unit comprising:
a base adapted to be mounted to an inside of the door;
a transmission mechanism rotatably mounted on the base and including a rotary shaft;
a drive device for rotating the rotary shaft, the drive device comprising a driven gear mounted on the rotary shaft for rotating therewith, a furcated component movably mounted on the base and meshing with the driven gear, a worm rotatably mounted on the base and meshing with a slide block for pushing the furcated component, a motor provided on the base to drive a group of gears which drives the worm, said worm and said slide being so meshed that when the worm rotates, the slide block moves linearly;
an outer lock unit adapted to be attached to an outside of the door and including an elongated rotor rotatably mounted thereon, the elongated rotor in turn fittingly extending through the rotary core and the rotary shaft, whereby when the motor runs to rotate the worms, the slide block linearly moves to cause the rotary shaft to rotate, which in turn causes the rotary core to rotate, the rotation of the rotary core resulting in a linear movement of the latch to extend out of the lock bolt or retract into lock bolt from an extended position.

2. The motor-driving lock as described in claim 1, wherein the transmission mechanism further comprises a rotary base from which the rotary shaft extends and a support base fixed to the rotary base, each of the rotary base and support base defining a cross-shaped slot into which the elongated rotor extends.

3. The motor-driving lock as described in claim 1, wherein the furcated component is located between a pair of positioning blocks and moves within a slideway and a U-shaped block.

4. The motor-driving lock assembly as described in claim 1, wherein the furcated component includes a pair of resilient strips each forming a small protrusion projecting into the furcated component and engaging with the slide block.

5. The motor-driving lock as described in claim 1, wherein the furcated component includes a sensor plate attached thereon;

6. The motor-driving lock assembly as described in claim 5, wherein the inner lock unit further includes a pair of switches mounted on the base, said switches engage with the sensor plate at different positions of the furcated component.

7. The motor-driving lock as described in claim 1, wherein the inner lock unit further comprises an electrical connector mounted on the base which is adapted to be connected to an remote control circuit for remotely controlling the running of the motor.

8. The motor-driving lock as described in claim 1, wherein the inner lock unit further includes several brackets fixedly mounted on the base for supporting the motor, gears and worm.

9. The motor-driving lock as described in claim 1 further comprising a positioning plate attached to the base, the positioning plate defining a recess for receiving the rotary shaft and a restraining block , a gasket and a spring which are fitted around the rotary shaft.

10. The motor-driving lock as described in claim 1, wherein the positioning plate comprising a center hole in the recess for receiving the rotary shaft.

11. A motor-driving lock comprising:
a rotary shaft connected to a latch of a door;
driven gear associatively moveable with the rotary shaft;
a linear moveable component defining rack part engaged with the driven gear; and
a linear moveable slide block actuating the component to move in two opposite directions, said slide block actuated to move by a worm which is rotated by electrical control; wherein
via rotation of said worm, the latch performs projection and retraction relative to the door.

12. The lock as described in claim 11, wherein said slide block is engageable with while discrete from the component.

13. The lock as described in claim 11, wherein said slide block makes a linear movement relative to the component.

14. The lock as described in claim 11, where the component includes means for cooperation with sensors.

15. The lock as described in claim 11, at least one of said component and said slide block includes resilient strips to allow the slide block to move relative to the component.

16. The lock as described in claim 11, wherein the component moves in a direction perpendicular to an axis of said rotary shaft.

17. The lock as described in claim 11, wherein said driven gear is coaxial with the rotary shaft.

18. A method of locking or unlocking a door via electrical control, comprising the steps of:
providing a lock bolt connected to a latch locking the door;
providing a rotary shaft connected to the lock bolt;
associating a driven gear with the rotary shaft;
providing a linearly moveable component with a rack part engaged with the driven gear;
providing a linearly moveable slide block urging the component to move;
providing means for actuating said slide block to move; and
providing electrical control to actuate said means to move.
